(19) United States
(12) Patent Application Publication
(10) Pub. No.: US 2021/0294155 A1
(43) Pub. Date: Sep. 23, 2021

(54) OPTICAL MODULE AND WAVELENGTH-SELECTIVE SWITCH

(71) Applicant: FUJIKURA LTD., Tokyo (JP)

(72) Inventor: Koichiro Iwata, Sakura-shi (JP)

(73) Assignee: FUJIKURA LTD., Tokyo (JP)

(21) Appl. No.: 16/317,973

(22) PCT Filed: Jun. 8, 2017
(86) PCT No.: PCT/JP2017/021395

§ 371 Date: Jan. 15, 2019

(30) Foreign Application Priority Data
Aug. 8, 2016 (JP) 2016-155714

(51) Int. Cl. G02F 1/1335; G02B 5/08

(52) U.S. Cl. CPC G02F 1/133553; G02B 5/08; G02F 1/133524

(57) ABSTRACT

The present invention appropriately holds an optical component without damage and reduces parts count. An optical switching module (15) includes: a reflector element (32); a housing (31); and an angled window member (33) that includes inclined faces (33a, 33b) whose normal directions are different from each other and that guides light beams incident on the respective inclined faces (33a, 33b) to respective different segments (first region (32a) and second region (32b)) of the light receiving surface of the reflector element (32).

### TECHNICAL FIELD

An embodiment of the present invention relates to an optical module in which a housing, which stores an optical element therein, is sealed with a window member that is provided to the housing and that allows passage of optical signals, and relates to a wavelength selective switch.

### BACKGROUND ART

An optical module including an optical element such as liquid crystal on silicon (LCOS) has been known. Patent Literature 1 discloses a wavelength selective switch including LCOS as a reflector element that controls the direction of reflection of an optical signal. Patent Literature 1 uses a single reflector element as a two to three waveband selective switch.

This kind of wavelength selective switch is arranged such that: a wavelength-multiplexed signal beam output from an optical fiber is collimated into a parallel beam through a collimating lens system; the beam is further split into different wavelengths through a prism; and the beam is further collimated to a parallel beam through a lens system and guided to a reflector element, which is an optical element. With this arrangement, at a reflective part, rays of a light beam coming from a single optical fiber are reflected at different positions depending on their wavelength.

In the above arrangement, by changing the direction of reflection of incident light perpendicularly to the wavelength direction of the reflector element, it is possible to have the light travel back to a position different from the position from which the incident light has come. This makes it possible, by placing a plurality of optical fibers along with each other and controlling the direction of light reflection such that the direction of light reflection differs from one position of the reflector element to another, to achieve a wavelength selective switch that causes different wavelength components of an optical signal to enter respective different optical fibers. In particular, Patent Literature 1 discloses an arrangement in which: optical components each in the shape of a wedge are inserted near the LCOS and the optical fibers, respectively; the reflective part of the LCOS is used as two separate segments; and thereby a single reflector element is used as a wavelength selective switch that includes two wavelength selecting sections.

Patent Literature 2 discloses an arrangement in which a lid with a light transmissive member is seam welded to a housing that stores an optical element therein, and thereby the inside of the housing is sealed.

Patent Literature 3 discloses an arrangement in which a housing that stores an optical semiconductor device therein is sealed with a lid with a light transmissive window. Patent Literature 3 also discloses that the window and the lid are formed integrally from the same material, that the window has an inclined face for antireflection, and that the window has a lens for achieving improved light input/output efficiency when light is input and output.

### CITATION LIST

### Patent Literature

[Patent Literature 1]

Japanese Patent Application Publication, Tokukai, No. 2015-158651

[Patent Literature 2]

Japanese Patent Application Publication, Tokukai, No. 2015-31903

[Patent Literature 3]

Japanese Patent Application Publication, Tokukai, No. 2006-128514

### SUMMARY OF INVENTION

### Technical Problem

Wires for an optical element itself such as LCOS, and wires connecting between the optical element and nearby components, are prone to deterioration from ambient temperature and humidity or foreign matter ingress. To address this, the housing for storing the optical element therein is required to be hermetically sealed to maintain long-term reliability and to prevent failures that would be caused by short-circuits in wires.

In this regard, Patent Literature 1 fails to disclose any specific housing that stores an optical element therein.

Furthermore, an arrangement in which a single optical element's operation segment is used as two or more separate operation segments necessitates an optical component that guides optical signals to respective different segments of a light receiving surface of the optical element, such as the foregoing wedge-shaped optical component. This increases parts count, and necessitates a structure that appropriately holds such an optical component in place without damage or position/angle displacement.

Patent Literatures 2 and 3 disclose an arrangement in which a housing that stores an optical element therein is hermetically sealed, but never mentions an optical component like that discussed above.

In view of this, an object of an embodiment of the present invention is to provide an optical module that is capable of appropriately holding an optical component, which guides optical signals to respective different segments of a light receiving surface of an optical element, without damage or position/angle displacement and that is capable of reducing the parts count.

### Solution to Problem

In order to attain the above object, an optical module in accordance with one aspect of the present invention includes: an optical element including a light receiving surface; a housing that stores the optical element therein; and a window member disposed on the housing so as to seal an inside of the housing, the window member being an angled window member that includes first and second surfaces opposite each other, the first surface being an upper surface or a lower surface and including a plurality of faces whose normal directions are different from each other, the second surface being a flat surface that is parallel to the light receiving surface of the optical element, the angled window member being configured to guide light beams, which are incident on the respective plurality of faces of the first surface, to respective different segments of the light receiving surface of the optical element.

### Advantageous Effects of Invention

According to an arrangement in accordance with one aspect of the present invention, since an optical module includes an angled window member, it is possible to reduce the parts count of an optical apparatus including the optical module. Furthermore, since the angled window member serving as an optical component is secured to the housing at the periphery of its surface facing the housing to seal the inside of the housing, the angled window member is less prone to damage despite its thin periphery and is held appropriately in place without position/angle displacement.

### BRIEF DESCRIPTION OF DRAWINGS

FIG. 1 is a plan view illustrating a configuration of an optical system of a wavelength selective switch including an optical switching module in accordance with an embodiment of the present invention.

FIG. 2 is a side view of the wavelength selective switch shown in FIG. 1.

FIG. 3 is a perspective view of the optical switching module shown in FIG. 1.

FIG. 4 is a vertical cross-sectional view of the optical switching module shown in FIG. 3.

FIG. 5 is an explanatory drawing for the angles of major portions of an angled window member shown in FIG. 3.

(a) of FIG. 6 is a schematic view illustrating an arrangement in which a ridge serving as the border between two inclined faces of the angled window member shown in FIG. 1 is parallel to one of two orthogonal directions of a grid of a reflector element. (b) of FIG. 6 is a schematic view illustrating an arrangement in which the ridge is at an angle to each of the two orthogonal directions of the grid of the reflector element.

FIG. 7 is an explanatory drawing for a first segment of the reflector element where optical signal components of wavelengths λ1 to λ5, which are illustrated in FIG. 2, enter respective different areas of the first segment of the reflector element.

FIG. 8 is an explanatory drawing for a configuration of an optical switching module of another embodiment of the present invention.

FIG. 9 is an explanatory drawing for a configuration of an optical switching module of a further embodiment of the present invention.

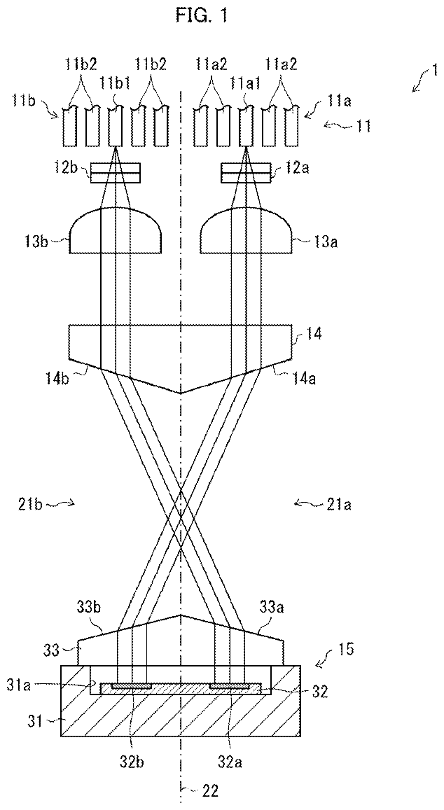

(a) of FIG. 10 is a schematic view illustrating a configuration of the wavelength selective switch including the optical switching module illustrated in FIG. 1. (b) of FIG. 10 is a schematic view illustrating a configuration of a wavelength selective switch including an optical switching module of still a further embodiment of the present invention. (c) of FIG. 10 is a schematic view illustrating a configuration of a wavelength selective switch including an optical switching module of still a further embodiment of the present invention.

### DESCRIPTION OF EMBODIMENTS

### Embodiment 1

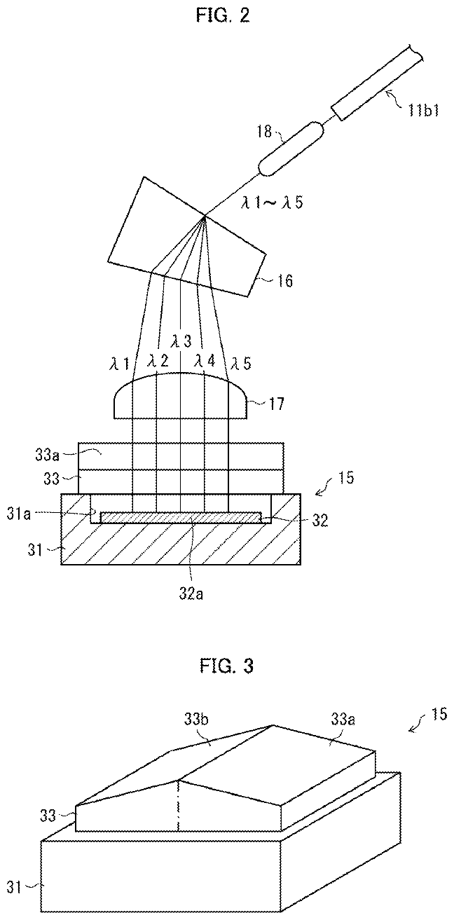

The following description will discuss an embodiment of the present invention with reference to drawings. FIG. 1 is a plan view illustrating a configuration of an optical system of a wavelength selective switch including an optical switching module in accordance with Embodiment 1. FIG. 2 is a side view of the wavelength selective switch shown in FIG. 1.

(Configuration of Wavelength Selective Switch)

As illustrated in FIG. 1, the wavelength selective switch 1 includes input/output optical fiber groups 11a and 11b, collimating lenses 12a and 12b, collimating lenses 13a and 13b, an optical component 14, and an optical switching module 15. These constituents are arranged in the order named from the input/output optical fiber groups 11a and 11b to the optical switching module 15.

As illustrated in FIG. 2, the wavelength selective switch 1 further includes a prism 16 and a collimating lens 17. Note that the prism 16 and the collimating lens 17 here may alternatively be two pairs of a prism 16 and a collimating lens 17 corresponding to the respective input/output optical fiber groups 11a and 11b; however, in the configuration illustrated in FIGS. 1 and 2, a single prism 16 and a single collimating lens 17 may each be shared by the input/output optical fiber groups 11a and 11b. Further note that the prism 16 and the collimating lens 17, which are illustrated in FIG. 2, are not illustrated in FIG. 1 for simpler illustration and to help easy understanding of the configuration of the wavelength selective switch 1. The actual positions of the prism 16 and the collimating lens 17 are between the optical component 14 and the optical switching module 15. Also note that an optical system unit 18 represents a collection of the collimating lenses 12a and 12b, the collimating lenses 13a and 13b, and the optical component 14, which are illustrated in FIG. 1.

Assume here that a region extending from the input/output optical fiber groups 11a and 11b to the optical switching module 15 of the wavelength selective switch 1 is divided into: a first region 21a which is in the right half of FIG. 1 and which includes the input/output optical fiber group 11a; and a second region 21b which is in the left half of FIG. 1 and which includes the input/output optical fiber group 11b. The centerline in a dot-dash line indicates a borderline 22 between the first region 21a and the second region 21b.

The input/output optical fiber group 11a and the input/output optical fiber group 11b are arranged side by side with each other. The input/output optical fiber group 11a includes a plurality of optical fibers 11a1 and 11a2, and the input/output optical fiber group 11b includes a plurality of optical fibers 11b1 and 11b2. The optical fibers 11a1 and 11b1 here serve to send light toward the optical switching module 15, whereas the optical fibers 11a2 and 11b2 here serve to receive light from the optical switching module 15. The optical fibers 11a1 and 11a2 and the optical fibers 11b1 and 11b2 are arranged side by side such that their ends are aligned with each other.

The collimating lens 12a, which corresponds to the input/output optical fiber group 11a, serves to collimate light received from the optical fiber 11a1 into parallel rays which are parallel to each other and each of which is perpendicular to the surface of the sheet on which FIG. 1 is printed. The collimating lens 12b, which corresponds to the input/output optical fiber group 11b, serves to collimate light received from the optical fiber 11b1 into parallel rays which are parallel to each other and each of which is perpendicular to the surface of the sheet on which FIG. 1 is printed.

The collimating lens 13a, which corresponds to the input/output optical fiber group 11a, serves to collimate light received via the collimating lens 12a into parallel rays which are parallel to each other and each of which is parallel to the surface on which the sheet on which FIG. 1 is printed. The collimating lens 13b, which corresponds to the input/output optical fiber group 11b, serves to collimate light received via the collimating lens 12b into parallel rays which are parallel to each other and each of which is parallel to the surface of the sheet on which FIG. 1 is printed.

The optical component 14 has a shape of a wedge whose portion in the first region 21a and whose portion in the second region 21b are symmetrical with each other with respect to the borderline 22. The optical component 14 is thicker at the borderline 22 and is thinner in the portion in the first region 21a and in the portion in the second region 21b. In other words, the optical component 14 is in the form of a pentagonal prism having an uninclined light entrance face that faces the collimating lenses 13a and 13b, and inclined light exit faces 14a and 14b that face the optical switching module 15. The inclined face 14a resides in the first region 21a, whereas the inclined face 14b resides in the second region 21b.

Specifically, the optical component 14 is in the shape of a pentagonal prism that includes: a triangular prism portion whose bottom is in the shape of an isosceles triangle; and a quadratic prism portion whose bottom is in the shape of a rectangle. The quadratic prism portion includes a side face that is equal in shape to a side face, of the triangular prism, which includes the base of the isosceles triangle. Assuming that a cross section of the optical component 14 is in a mountain-like shape, the ridge (borderline) of the mountain-like shape in FIG. 1 coincides with the borderline 22.

(Configuration of Optical Switching Module)

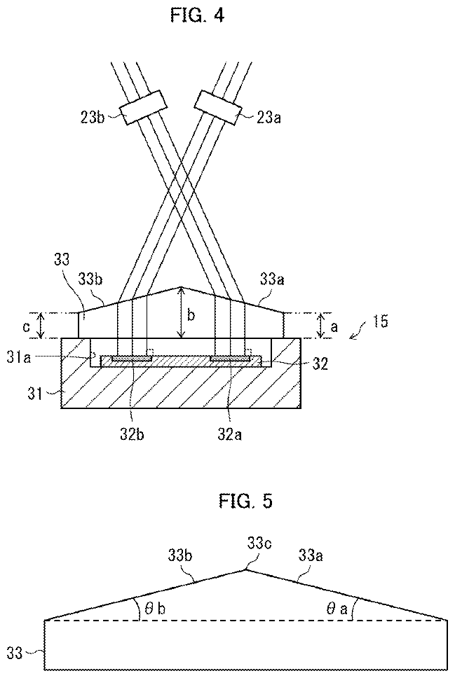

FIG. 3 is a perspective view of the optical switching module shown in FIG. 1. FIG. 4 is a vertical cross-sectional view of the optical switching module shown in FIG. 3. FIG. 5 is an explanatory drawing for the angles of major portions of an angled window member shown in FIG. 3. Note that, as to members 23a and 23b shown in FIG. 4, the member 23a is an optical component that serves to direct an optical signal to a second segment 32b of a reflector element 32, whereas the member 23b is an optical component that serves to direct an optical signal to a first segment 32a of the reflector element 32.

The optical switching module 15 includes, in a recess 31a in a housing 31, the reflector element 32 constituted by, for example, liquid crystal on silicon (LCOS), as illustrated also in FIGS. 3 and 4. The housing 31 is in the shape of, for example, a rectangular box with an open top. The inside of the housing 31 is hermetically sealed with an angled window member 33 located on top of the housing 31. Note that the reflector element 32 is provided with electric wiring for control of the reflector element 32, and the reflector element 32 is connected to apparatus outside the housing 31 (this arrangement is not illustrated).

As with the optical component 14, the angled window member 33 also has a shape of a wedge whose portion in the first region 21a and whose portion in the second region 21b are symmetrical with each other with respect to the borderline 22. The angled window member 33 is also thicker at the borderline 22 and is thinner in the portion in the first region 21a and in the portion in the second region 21b. The optical switching module 15 in Embodiment 1 is in the form of a pentagonal prism having inclined light entrance faces 33a and 33b that face the optical component 14, and an uninclined face on the housing 31-side. The inclined face 33a resides in the first region 21a, whereas the inclined face 33b resides in the second region 21b.

Specifically, the angled window member 33 is in the shape of a pentagonal prism that includes: a triangular prism portion whose bottom is in the shape of an isosceles triangle; and a quadratic prism portion whose bottom is in the shape of a rectangle. The quadratic prism portion includes a side face that is equal in shape to a side face, of the triangular prism, which includes the base of the isosceles triangle. Assuming that a cross section of the optical switching module 15 is in a mountain-like shape, the ridge of the mountain-like shape in FIG. 1 coincides with the borderline 22.

The optical switching module 15, which is structured as described above, is such that, in FIG. 4, a height a at the first-region-21a-side end is equal to a height c at the second-region-21b-side end (i.e., a=c) and that a height b at the center (ridge) is greater than the height a and the height c.

Furthermore, as illustrated in FIG. 5, an angle of inclination θa of the inclined face 33a and an angle of inclination θb of the inclined face 33b are equal to each other. Note that the angled window member 33 is not limited to an arrangement in which the angle of inclination θa of the inclined face 33a and the angle of inclination θb of the inclined face 33b are equal to each other. The angled window member 33 may be arranged such that the angle of inclination θa and the angle of inclination θb are different from each other, that is, the angled window member 33 may have an asymmetrical shape.

The angled window member 33 preferably has an anti-reflection coating thereon which corresponds to the wavelength of light to be used.

The angled window member 33 is in the shape of a pentagonal prism having some thickness, in order to ensure a strength as a window member; however, the angled window member 33, when simply used only to bend optical paths, is not limited to the shape of a pentagonal prism, and may be constituted only by, for example, the triangular prism portion above the dotted line illustrated in FIG. 5. The angled window member 33, even in the shape of a triangular prism, is capable of ensuring the strength to the extent that damage can be prevented, because the angled window member 33 is secured to the housing 31 at its periphery.

A material for the housing 31 can be, for example, a ceramics material such as alumina or aluminum nitride, or a metal such as kovar. The material for the angled window member 33 can be, for example, a kind of borosilicate glass (trade name: Kovar (registered trademark) glass, Tempax (registered trademark) glass), sapphire, or quartz.

When the housing 31 is sealed with the angled window member 33, the amount of moisture inside the housing 31 (the dew point inside the housing 31) can be controlled by removing moisture by baking in vacuo or the like and then carrying out the sealing action in a dry atmosphere.

A material (sealer) used to secure the angled window member 33 to the housing 31 to seal the housing 31 can be an adhesive, low-melting glass, solder (e.g., AuSn20), or the like, each of which achieves a high level of hermeticity. In a case where solder is used as the sealer, the angled window member 33 and the housing 31 are preferably metallized. Using an elastic resin or the like as the sealer is preferred to ensure the bond strength of the optical switching module 15, particularly when the angled window member 33 and the housing 31 differ greatly in linear expansion coefficient from each other.

Use of low-melting glass or solder as the sealer makes it possible to ensure a high level of hermeticity as high as when the sealing is carried out by seam welding. Furthermore, by carrying out local heating using a laser when low-melting glass or solder is used as the sealer, it is possible to reduce the impact of heat as compared to cases where heating is carried out using a heater.

In a case where an adhesive is used as the sealer to achieve hermetical sealing, the hermetical sealing can be achieved with the use of a simple apparatus, although the level of hermeticity depends on the performance of the adhesive used.

The linear expansion coefficients of the housing 31 and the angled window member 33 are preferably as close as possible to each other. Note however that, provided that the angled window member 33 satisfies a necessary strength, the linear expansion coefficients of the housing 31 and the angled window member 33 may not be close to each other.

(Use of Reflector Element as if it were Two Separate Elements)

The optical switching module 15 having the foregoing structure, whose angled window member 33 has two inclined faces (i.e., the inclined face 33a and 33b), is such that, because of the two inclined faces, the reflector element 32 can be used as if it were two separate elements separated by the borderline 22, i.e., the first segment 32a in the first region 21a and the second segment 32b in the second region 21b. Thus, the optical switching module 15 is capable of operating as a two-in-one optical switching module. Specifically, the optical switching module 15 is such that the inclined face 33a of the angled window member 33 corresponds to the first segment 32a of the reflector element 32 whereas the inclined face 33b of the angled window member 33 corresponds to second segment 32b of the reflector element 32, and that, since the angled window member 33 has the inclined faces 33a and 33b, the reflector element 32 can be used as if it were two separate elements.

(a) of FIG. 6 is a schematic view illustrating an arrangement in which a ridge (borderline) 33c serving as the border between the inclined face 33a and the inclined face 33b of the angled window member 33 is parallel to one of two orthogonal directions of a grid of the reflector element 32. (b) of FIG. 6 is a schematic view illustrating an arrangement in which the ridge 33c is at an angle to each of the two orthogonal directions of the grid of the reflector element 32.

As illustrated in (a) of FIG. 6, the reflector element 32 is such that its reflective portion is divided into small cells defined by a grid, and that the refractive index distribution can be controlled on a block-by-block basis (each block is quadrangle in shape and is a collection of two or more cells). As such, the reflector element 32 is capable of being adjusted as to the direction of reflection of incident light on a block-by-block basis.

Note that, as illustrated in (a) of FIG. 6, the optical switching module 15 is arranged such that the ridge 33c of the angled window member 33 is parallel to one of the two orthogonal directions of the grid of the reflector element 32. This makes it possible to easily control the reflector element 32 as to the direction of reflection on a cell-by-cell basis or on a block-by-block basis. That is, the arrangement as illustrated in (b) of FIG. 6, in which the ridge 33c of the reflector element 32 is at an angle to each of the two orthogonal directions of the grid of the reflector element 32, is not preferred.

(Adjustment of Wavelength Selective Switch)

In the wavelength selective switch 1, the positions of its optical components and the like are adjusted before use so that, when optical signals are output from the optical fibers 11a1 and 11b1 (i.e., optical fibers which serve to send light toward the optical switching module 15) toward the optical switching module 15, the optical signals are incident on the reflector element 32 of the optical switching module 15 at a right angle, are reflected at the reflector element 32, and then enter the optical fibers 11a1 and 11b1 (i.e., optical fibers which serve to send out light) in parallel to the optical axes of the optical fibers 11a1 and 11b1.

In the above condition, by adjusting the reflector element 32 (i.e., adjusting the reflection angle of the reflector element 32), it is possible to allow the optical signals, which are output from the optical fibers 11a1 and 11b1 (i.e., optical fibers which serve to send light toward the optical switching module 15) toward the optical switching module 15, to enter the optical fibers 11a2 and 11b2 (i.e., optical fibers which serve to receive light from the optical switching module 15) which are adjacent to the optical fibers 11a1 and 11b1. Note that the input/output optical fiber group 11a and its corresponding second segment 32b of the reflector element 32, and the input/output optical fiber group 11b and its corresponding first segment 32a of the reflector element 32, are capable of operating independently of each other.

(How Wavelength Selective Switch Operates when Reflector Element is Used as if it were Two Separate Elements)

The following description will discuss how the wavelength selective switch 1 operates in a case where, in the above-described structure, the reflector element 32 is used as if it were two separate elements.

As illustrated in FIG. 1, in the wavelength selective switch 1, an optical signal output from the optical fiber 11a1 (i.e., optical fiber which serves to send out light) of the input/output optical fiber group 11a travels through the first region 21a and is collimated into a parallel beam by the collimating lens 12a and the collimating lens 13a. Then, the optical signal is refracted at the optical component 14 such that its path goes from the first region 21a to the second region 21b, and is incident on the inclined face 33b of the angled window member 33 of the optical switching module 15. This optical signal is refracted at the inclined face 33b and its path is bent, and is incident on the second segment 32b of the reflector element 32 at a right angle.

In the above case, provided that the second segment 32b of the reflector element 32 is controlled such that light reflected at the second segment 32b travels toward the optical fibers 11a2 (i.e., optical fibers which serve to receive light), the optical signal that has been incident on the second segment 32b is reflected at the second segment 32b, travels a reverse route, and then enters the optical fibers 11a2 (i.e., optical fibers which serve to receive light) which are deviated in position from the optical fiber 11a1 (i.e., optical fiber which serves to sending out light).

Similarly, in the wavelength selective switch 1, an optical signal output from the optical fiber 11b1 (i.e., optical fiber which serves to send out light) of the input/output optical fiber group 11b travels through the first region 21b and is collimated into a parallel beam by the collimating lens 12b and the collimating lens 13b. Then, the optical signal is refracted at the optical component 14 such that its path goes from the second region 21b to the first region 21a, and is incident on the inclined face 33a of the angled window member 33 of the optical switching module 15. This optical signal is refracted at the inclined face 33a and its path is bent, and is incident on the first segment 32a of the reflector element 32 at a right angle.

In the above case, provided that the first segment 32a of the reflector element 32 is controlled such that light reflected at the first segment 32a travels toward the optical fibers 11b2 (i.e., optical fibers which serve to receive light), the optical signal that has been incident on the first segment 32a is reflected at the first segment 32a, travels a reverse route, and then enters the optical fibers 11b2 (i.e., optical fibers which serve to receive light) which are deviated in position from the optical fiber 11b1 (i.e., optical fiber which serves to send out light).

(Wavelength Selective Switch's Operation of Splitting Optical Signal into Different Frequency Components)

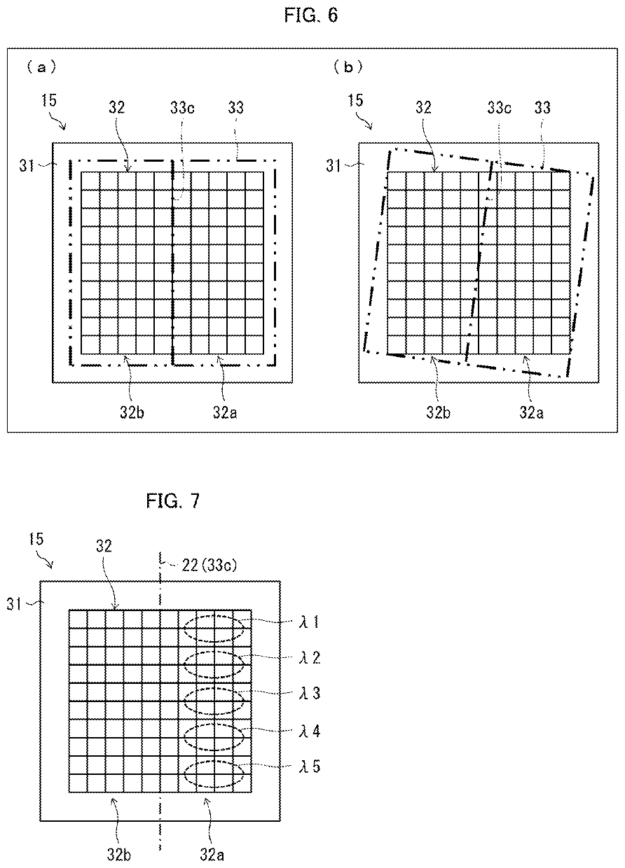

Next, the following description discusses how the wavelength selective switch 1 operates in a case of splitting an optical signal into different frequency components. FIG. 7 is an explanatory drawing for the first segment 32a of the reflector element 32 where optical signal components of wavelengths λ1 to λ5, which are illustrated in FIG. 2, are incident on respective different areas of the first segment 32a of the reflector element 32.

As described earlier with reference to FIG. 1 (i.e., plan view of the wavelength selective switch 1), an optical signal (light beam) output from the optical fiber 11b1 (i.e., optical fiber which serves to send out light) of the input/output optical fiber group 11b is incident on the first segment 32a of the reflector element 32. In this case, as illustrated in FIG. 2 (i.e., side view of the wavelength selective switch 1), the optical signal (including, for example, optical signal components of wavelengths λ1 to λ5), which is output from the optical fiber 11b1 (i.e., optical fiber which serves to send out light) of the input/output optical fiber group 11b, passes through the optical system unit 18 including the collimating lens 12b, the collimating lens 13b, and the optical component 14. Then, the optical signal, when passes through the prism 16, is split into different wavelength components (that is, split into rays spaced from one another along a direction parallel to the ridge 33c of the angled window member 33) because optical signal's refractive index differs depending on wavelength, collimated to be parallel by the collimating lens 17, refracted at the inclined face 33b of the angled window member 33, and then are incident on the first segment 32a of the reflector element 32 at a right angle.

In this case, as illustrated in FIG. 7, the optical signal components of wavelengths λ1 to λ5 are incident on respective different areas of the first segment 32a of the reflector element 32 which are arranged along the direction parallel to the ridge 33c of the angled window member 33, and the direction of reflection thereof is controlled on an area-by-area basis (e.g., on a cell-by-cell basis or on a block-by-block basis [a block includes two or more cells]) in the reflector element 32.

The wavelength selective switch 1 is, as illustrated in FIG. 1, arranged such that the optical component 14 having a shape of a symmetrical wedge is provided upstream of the optical switching module 15 and that the input/output optical fiber group 11b corresponding to the first segment 32a of the reflector element 32 and the input/output optical fiber group 11a corresponding to the second segment 32b of the reflector element 32 are arranged in a line. Note, however, that the wavelength selective switch 1 is not limited as such. Specifically, the optical component 14 is not essential to the wavelength selective switch 1, and the input/output optical fiber group 11a and the input/output optical fiber group 11b may be arranged in different positions (directions).

(Advantages of Optical Switching Module)

The optical switching module 15 is such that the housing 31, which stores the reflector element 32 therein, is sealed with the angled window member 33. The angled window member 33 has a plurality of inclined faces (light entrance faces) 33a and 33b, i.e., a plurality of faces whose normal directions are different from each other, at the upper surface of the angled window member 33, and these inclined faces (light entrance faces) 33a and 33b are arranged to guide incident light beams to respective different segments of the light receiving surface of the reflector element 32.

As such, the angled window member 33 not only serves as a window member to seal the inside of the housing 31, but also serves as an optical component that guides incident light beams to respective different segments of the light receiving surface of the reflector element 32. This makes it possible to reduce the parts count of an optical apparatus including the optical switching module 15, that is, the wavelength selective switch 1.

Furthermore, the angled window member 33 is secured to the housing 31 at the periphery of its surface facing the housing 31 to seal the inside of the housing 31. With this arrangement, the angled window member 33 is less prone to damage despite its thin periphery, and is held in position without position/angle displacement.

Note that the optical switching module 15 may be an optical module that includes some other optical element, such as a light receiving element, in place of the reflector element 32.

### Embodiment 2

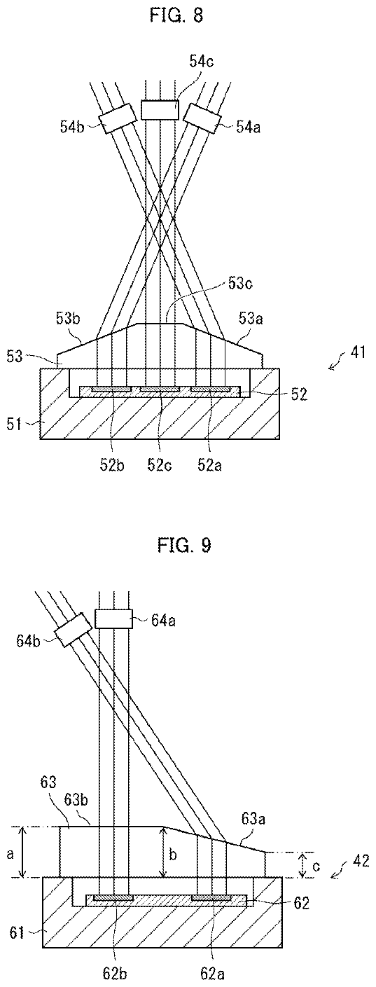

The following description will discuss another embodiment of the present invention with reference to a drawing. FIG. 8 is an explanatory drawing for a configuration of an optical switching module of Embodiment 2.

(Configuration of Optical Switching Module)

As illustrated in FIG. 8, an optical switching module 41 includes a housing 51, a reflector element 52, and an angled window member 53, which correspond to the housing 31, the reflector element 32, and the angled window member 33 of the optical switching module 15, respectively. The housing 51 and the reflector element 52 are the same in functions as the housing 31 and the reflector element 32, respectively.

The angled window member 53 has an uninclined face 53c in the middle thereof, and includes inclined faces 53a and 53b disposed such that the uninclined face 53c resides between the inclined faces 53a and 53b. These inclined faces 53a and 53b and the uninclined face 53c have respective different normal directions. The uninclined face 53c is parallel to a light receiving surface of the reflector element 52, whereas the inclined faces 53a and 53b are inclined toward the bottom of the angled window member 53 at the same angle to the uninclined face 53c. Note, however, that the inclined faces 53a and 53b may be inclined at different angles.

In the optical switching module 41, the angled window member 53 has the inclined faces 53a and 53b and the uninclined face 53c, and therefore the reflector element 52 can be used as if it were three separate elements (i.e., a first segment 52a, a second segment 52b, and a third segment 52c). Thus, the optical switching module 41 is capable of operating as a three-in-one optical switching module. Specifically, the inclined face 53a corresponds to the first segment 52a of the reflector element 52, the inclined face 53b corresponds to the second segment 52b of the reflector element 52, and the uninclined face 53c corresponds to the third segment 52c of the reflector element 52.

Note that, in regard to members 54a to 54c shown in FIG. 8, the member 54a is an optical component that directs an optical signal to the inclined face 53b of the angled window member 53 (and to the second segment 52b of the reflector element 52), the member 54b is an optical component that directs an optical signal to the inclined face 53a of the angled window member 53 (and to the first segment 52a of the reflector element 52), and the member 54c is an optical component that directs an optical signal to the uninclined face 53c of the angled window member 53 (and to the third segment 52c of the reflector element 52). The rest of the configuration of the optical switching module 41 is the same as that of the foregoing optical switching module 15.

(Advantages of Optical Switching Module)

The optical switching module 41 is superior to the optical switching module 15 in that the optical switching module 41 is larger in number of segments of the reflector element 52 and that more kinds of optical signal can be processed. The other advantages of the optical switching module 41 are the same as those of the optical switching module 15.

Note that, in the optical switching module 41, it is possible to further increase the number of segments of the reflector element 52 by increasing the number of light entrance faces (inclined faces) of the angled window member 53, in principle. However, in reality, the degree of an increase in the number of segments of the reflector element 52 will be restricted by the layout of input/output optical fibers of the wavelength selective switch 1, the area of the reflector element 52, and the like.

### Embodiment 3

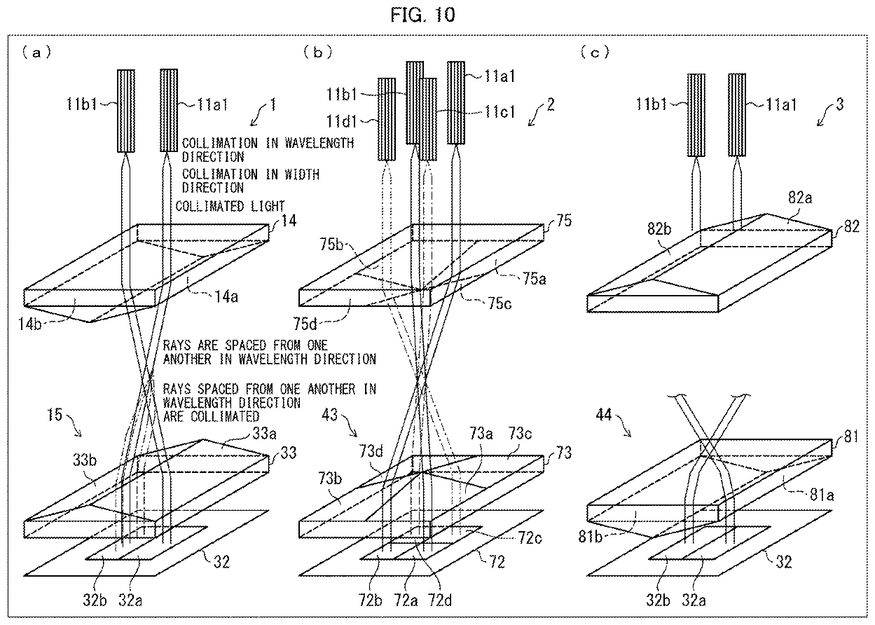

The following description will discuss a further embodiment of the present invention with reference to a drawing. FIG. 9 is an explanatory drawing for a configuration of an optical switching module of Embodiment 3.

(Configuration of Optical Switching Module)

As illustrated in FIG. 9, an optical switching module 42 includes a housing 61, a reflector element 62, and an angled window member 63, which correspond to the housing 31, the reflector element 32, and the angled window member 33 of the optical switching module 15, respectively. The housing 61 and the reflector element 62 are the same in functions as the housing 31 and the reflector element 32, respectively.

The angled window member 63 has an inclined face 63a and an uninclined face 63b (i.e., a plurality of faces whose normal directions are different from each other). The uninclined face 63b is parallel to a light receiving surface of the reflector element 62, whereas the inclined face 63a is inclined toward the bottom of the angled window member 63 at an angle to the uninclined face 63b.

In the optical switching module 42, the angled window member 63 has the inclined face 63a and the uninclined face 63b, and therefore the reflector element 62 can be used as if it were two separate elements (i.e., a first segment 62a and a second segment 62b). Thus, the optical switching module 42 is capable of operating as a two-in-one optical switching module. Specifically, the inclined face 63a corresponds to the first segment 62a of the reflector element 62, whereas the uninclined face 63b corresponds to the second segment 62b of the reflector element 62.

Note that, in regard to members 64a and 64b shown in FIG. 9, the member 64a is an optical component that directs an optical signal to the uninclined face 63b of the angled window member 63 (and to the second segment 62b of the reflector element 62), whereas the member 64b is an optical component that directs an optical signal to the inclined face 63a of the angled window member 63 (and to the first segment 62a of the reflector element 62). The rest of the configuration of the optical switching module 42 is the same as that of the foregoing optical switching module 15.

(Advantages of Optical Switching Module)

The angled window member 63 of the optical switching module 42 has the inclined face 63a and the uninclined face 63b (i.e., a plurality of faces whose normal directions are different from each other), and the thickness of the angled window member 63 is the same between position a and position b but is thinner at position c. Thus, the angled window member 63 is structured such that an optical signal reflected at the first segment 62b of the reflector element 62 travels straight upward and an optical signal reflected at the first segment 62a of the reflector element 62 is bent leftward.

In order to produce such an angled window member 63 by processing a glass material in the form of a sheet with parallel sides, it is only necessary to shave off only the right half so that the resulting face is inclined. This makes it possible to reduce production cost. The other advantages of the optical switching module 42 are the same as those of the optical switching module 15.

### Embodiment 4

The following description will discuss still further embodiments of the present invention with reference to a drawing. (a) of FIG. 10 is a schematic view illustrating a configuration of the wavelength selective switch 1 including the optical switching module 15 illustrated in FIG. 1. (b) of FIG. 10 is a schematic view illustrating a configuration of a wavelength selective switch 2 including an optical switching module 43 of still a further embodiment of the present invention. (c) of FIG. 10 is a schematic view illustrating a configuration of a wavelength selective switch 3 including an optical switching module 44 of still a further embodiment of the present invention. Note that (a) to (c) of FIG. 10 do not illustrate optical components other than optical fibers, optical components that have a plurality of inclined faces and that are configured to bend the optical path of collimated light, and an optical switching module, for easy understanding of the optical paths of optical signals.

(Configuration of Optical Switching Module)

The optical switching module 43 illustrated in (b) of FIG. 10 includes an angled window member 73 having four inclined faces (i.e., a plurality of faces whose normal directions are different from each other) 73a to 73d, as compared to the optical switching module 15 in which the angled window member 33 has two inclined faces 33a and 33b as illustrated in (a) of FIG. 10. Thus, a reflector element 72 is used as if it were four separate elements (i.e., first segment 72a to fourth segment 72d). That is, the optical switching module 43 is used as a four-in-one switching module.

The wavelength selective switch 2, which includes the switching module 43, includes an optical component 75, which corresponds to the optical component 14 shown in (a) of FIG. 10. The optical component 75 has four inclined faces 75a to 75d, as with the angled window member 73.

In the wavelength selective switch 2, an optical signal output from an optical fiber 11a1 (i.e., optical fiber which serves to send out light) passes through the inclined face 75a of the optical component 75 and through the inclined face 73b of the angled window member 73, and is incident on the second segment 72b of the reflector element 72. An optical signal output from an optical fiber 11b1 (i.e., optical fiber serves to end out light) passes through the inclined face 75b of the optical component 75 and through the inclined face 73a of the angled window member 73, and is incident on the first segment 72a of the reflector element 72. An optical signal output from an optical fiber 11c1 (i.e., optical fiber which serves to send out light) passes through the inclined face 75c of the optical component 75 and through the inclined face 73d of the angled window member 73, and is incident on the fourth segment 72d of the reflector element 72. An optical signal output from an optical fiber 11d1 (i.e., optical fiber which serves to send out light) passes through the inclined face 75d of the optical component 75 and through the inclined face 73c of the angled window member 73, and is incident on the third segment 72c of the reflector element 72.

Note that, in principle, a reflector element of an optical switching module can be used as if it were nine separate elements; however, this arrangement is not illustrated, because is difficult to illustrate in a drawing.

The optical switching module 44 illustrated in (c) of FIG. 10 includes an angled window member 81, as compared to the optical switching module 15 which includes the angled window member 33 shown in (a) of FIG. 10. The shape of the angled window member 81 is a vertically inverted version of the shape of the angled window member 33 (i.e., light entrance surface and light exit surface are swapped). The angled window member 81 has inclined faces (i.e., a plurality of faces whose normal directions are different from each other) 81a and 81b.

The wavelength selective switch 3, which includes the switching module 44, includes an optical component 82, which corresponds to the optical component 14 shown in (a) of FIG. 10. The optical component 82 has a shape that is a vertically inverted version of the shape of the optical component 14 (i.e., light entrance surface and light exit surface are swapped), and has inclined faces 82a and 82b.

The optical switching module 44, which includes such an angled window member 81, can also have similar functions to the optical switching module 15.

[Recap]

An optical module in accordance with one aspect of the present invention includes: an optical element including a light receiving surface; a housing that stores the optical element therein; and a window member disposed on the housing so as to seal an inside of the housing, the window member being an angled window member that includes first and second surfaces opposite each other, the first surface being an upper surface or a lower surface and including a plurality of faces whose normal directions are different from each other, the second surface being a flat surface that is parallel to the light receiving surface of the optical element, the angled window member being configured to guide light beams, which are incident on the respective plurality of faces of the first surface, to respective different segments of the light receiving surface of the optical element.

According to the above arrangement, light beams, such as optical signals, which are incident on respective different faces of the first surface of the angled window member are guided to respective different segments of the light receiving surface of the optical element. With this arrangement, the optical element's segment can be used as if it were two or more separate segments. Furthermore, the angled window member serves not only as a window member that seals the inside of the housing but also as an optical component that guides incident light beams to respective segments of the light receiving surface of the optical element. This makes it possible to reduce the parts count of an optical apparatus including the optical module.

Furthermore, since the angled window member is secured to the housing at the periphery of its surface facing the housing to seal the inside of the housing, the angled window member is less prone to damage despite its thin periphery and is held in place without position/angle displacement.

The optical module may be arranged such that: the first surface of the angled window member is the upper surface and the second surface of the angled window member is the lower surface; the plurality of faces of the first surface are a plurality of inclined faces whose normal directions are different from each other; and the plurality of inclined faces form a mountain-like shape.

According to the above arrangement, the optical element can be used as an optical element having the same number of separate operation segments as the number of the plurality of inclined faces of the first surface of the angled window member.

The optical module may be arranged such that the plurality of inclined faces of the first surface of the angled window member are two inclined faces forming the mountain-like shape.

According to the above arrangement, the optical element can be used as an optical element having two separate operation segments, which is as many as the two inclined faces of the first surface of the angled window member.

The optical module may be arranged such that: the first surface of the angled window member is the upper surface and the second surface of the angled window member is the lower surface; and the plurality of faces, whose normal directions are different from each other, of the first surface are composed of (i) two inclined faces forming a mountain-like shape and (ii) one uninclined face which resides between the two inclined faces and which is parallel to the light receiving surface of the optical element.

According to the above arrangement, the optical element can be used as an optical element having three separate operation segments, which is as many as the sum of the two inclined faces and one uninclined face of the first surface of the angled window member.

The optical module may be arranged such that: the first surface of the angled window member is the upper surface and the second surface of the angled window member is the lower surface; and the plurality of faces, whose normal directions are different from each other, of the first surface are composed of (i) one uninclined face which is parallel to the light receiving surface of the optical element and (ii) one inclined face which is inclined with respect to the one uninclined face.

According to the above arrangement, the optical element can be used as an optical element having two separate operation segments, which is as many as the sum of the one uninclined face and one inclined face of the first surface of the angled window member.

The optical module may be arranged such that a borderline between adjacent ones of the plurality of faces of the first surface of the angled window member is parallel to one of two orthogonal directions of a grid of the optical element.

According to the above arrangement, since a borderline between adjacent ones of the plurality of faces of the first surface of the angled window member is parallel to one of the two orthogonal directions of a grid of the optical element, the optical element can be easily controlled.

The optical module may be arranged such that the optical element is a reflector element that is capable of being controlled as to a direction of light reflection of the light receiving surface on an area-by-area basis.

According to the above arrangement, the optical element is a reflector element that is capable of being controlled as to the direction of light reflection of the light receiving surface on an area-by-area basis. Thus, the optical element can be used as a reflector element having two or more separate reflective areas.

The optical module may be arranged such that the reflector element is liquid crystal on silicon (LCOS).

According to the above arrangement, it is possible to easily configure an optical module using a general-purpose LCOS as an optical element, that is, as a reflector element.

A wavelength selective switch in accordance with another aspect of the present invention includes: an optical module that includes a reflector element as an optical element; an optical fiber for input and output of an optical signal; and an optical system unit which resides between the optical module and the optical fiber and which is configured to optically couple the optical module and the optical fiber.

According to the above arrangement, it is possible to configure a good wavelength selective switch using an optical module that includes the foregoing reflector element as an optical element.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1, 2, 3 Wavelength selective switch
11a, 11b Input/output optical fiber group
11a1, 11b1, 11c1, 11d1 Optical fiber
12a, 12b Collimating lens
13a, 13b Collimating lens
14, 75, 82 Optical component
14a-14b, 75a-75d, 82a-82b Inclined faces
15, 41, 42, 43, 44 Optical switching module
18 Optical system unit
21a First region
21b Second region
22 Borderline
31 Housing
32,52,62,72 Reflector element
32a, 52a, 62a, 72a First region
32b, 52b, 62b, 72b Second region
52c, 73c Third region
72d Fourth region
33, 53, 63, 73, 81 Angled window member
33a-33b, 53a-53b, 63a, 73a-73d, 81a-81b Inclined face(s)
53c, 63b Uninclined face

1. An optical module comprising:
an optical element including a light receiving surface;
a housing that stores the optical element therein; and
a window member disposed on the housing so as to seal an inside of the housing,
the window member being an angled window member that includes first and second surfaces opposite each other, the first surface being an upper surface or a lower surface and including a plurality of faces whose normal directions are different from each other, the second surface being a flat surface that is parallel to the light receiving surface of the optical element, the angled window member being configured to guide light beams, which are incident on the respective plurality of faces of the first surface, to respective different segments of the light receiving surface of the optical element.

2. The optical module according to claim 1, wherein: the first surface of the angled window member is the upper surface and the second surface of the angled window member is the lower surface; the plurality of faces of the first surface are a plurality of inclined faces whose normal directions are different from each other; and the plurality of inclined faces form a mountain-like shape.

3. The optical module according to claim 2, wherein the plurality of inclined faces of the first surface of the angled window member are two inclined faces forming the mountain-like shape.

4. The optical module according to claim 1, wherein: the first surface of the angled window member is the upper surface and the second surface of the angled window member is the lower surface; and the plurality of faces, whose normal directions are different from each other, of the first surface are composed of (i) two inclined faces forming a mountain-like shape and (ii) one uninclined face which resides between the two inclined faces and which is parallel to the light receiving surface of the optical element.

5. The optical module according to claim 1, wherein: the first surface of the angled window member is the upper surface and the second surface of the angled window member is the lower surface; and the plurality of faces, whose normal directions are different from each other, of the first surface are composed of (i) one uninclined face which is parallel to the light receiving surface of the optical element and (ii) one inclined face which is inclined with respect to the one uninclined face.

6. The optical module according to claim 1, wherein a borderline between adjacent ones of the plurality of faces of the first surface of the angled window member is parallel to one of two orthogonal directions of a grid of the optical element.

7. The optical module according to claim 1, wherein the optical element is a reflector element that is capable of being controlled as to a direction of light reflection of the light receiving surface on an area-by-area basis.

8. The optical module according to claim 7, wherein the reflector element is liquid crystal on silicon (LCOS).

9. A wavelength selective switch comprising:
the optical module recited in claim 7;
an optical fiber for input and output of an optical signal; and
an optical system unit which resides between the optical module and the optical fiber and which is configured to optically couple the optical module and the optical fiber.
